(19) United States
(12) Patent Application Publication
(10) Pub. No.: US 2002/0116213 A1
(43) Pub. Date: Aug. 22, 2002

(54) System and method for viewing supply chain network metrics

(75) Inventors: Julia Burrows Kavounis, Germantown, MD (US); Ajit Shaligram Kale, Gaithersburg, MD (US); Scott Edward Snowberger, Germantown, MD (US); Marcia Laign Walker, Herndon, VA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD

(21) Appl. No.: 10/059,055

(22) Filed: Jan. 30, 2002

Related U.S. Application Data
(60) Provisional application No. 60/264,717, filed on Jan. 30, 2001.

(51) Int. Cl. G06F 17/60

(52) U.S. Cl. 705/1

(57) ABSTRACT

A method and system for retrieving and processing data from disparate network applications and displaying the processed data through a single user interface. The method includes retrieving data from disparate network applications using an ETL engine then storing the data in a multidimensional database. An OLAP server may then use the stored data to create key performance indicators based on the data from the various disparate network applications and display the key performance indicators through a single user interface.

### CROSS REFERENCE TO RELATED APPLICATIONS

This application claims priority from U.S. Provisional Patent Application Serial No. 60/264,717 filed Jan. 30, 2001, the disclosure of which is hereby incorporated by reference in its entirety.

### BACKGROUND OF THE INVENTION

1. Field of the Invention

The present invention disclosed herein relates to a configurable system and method for measuring and analyzing the performance of a trading network. More particularly, the present invention pertains to a system and method for providing an understandable, multi-dimensional, fully integrated view of business data, reusable metrics and measures through a single user interface.

2. Discussion of the Related Art

In today's fast paced industries, the measuring and analyzing of the performance by a given company of its trading network is critical to optimizing the planning, execution, and collaboration of network activities. More and more so, the adopting of comprehensive performance measures and metrics is required to uncover hidden performance opportunities. However, the compilation and comparison of such measures and metrics are difficult and time consuming tasks for even the most skilled managers. The key to addressing such issues is leveraging business applications designed specifically to provide intuitive, powerful business intelligence. Therefore, it is an object of the present invention to provide a solution that incorporates online analytical processing tools (“OLAP”), data warehousing and ETL engine technology to compile and manage these measures and metrics and thus provide significant business value and high return on investment.

Today's enterprises face a dynamic business environment that is extremely competitive and unforgiving. To remain competitive, an enterprise must be able to quickly gather, parse and analyze data from various sources. These sources may include divisions within an enterprise and/or outside sources such as supply chain trading partners like customers and suppliers. Unfortunately the data retain from these various sources may be in incompatible formats and/or originate from different types of applications which make it difficult to integrate the various disparate data and provide useful analytical results. In fact, even data from multiple divisions within the same enterprise may not be compatible even though it may be highly desirable to be able to view and/or merge the data from these different divisions and/or sources

Traditional performance measurement and reporting tools have been in existence for a time. However, these tools are generally limited in providing the functionality necessary for users to remain competitive in today's cutthroat business environment. Further, the business climate has become more complex as a result of the interdependencies across trading networks.

Performance metrics can no longer be isolated to specific functional areas or silos. Conventional tools for analyzing business performance are somewhat limited in their abilities to provide a comprehensive analysis of business performance in that typically they are only able to provide analysis of one specific segment of the business. For example, conventional tools are unable to integrate the various data from various segments of a business such as marketing, manufacturing, ordering, warehousing, and the like. One reason for this is because the data relating to the various business segments are typically not compatible for various reasons including incompatible formats, database remoteness, lack of connectivity between the segments and the like. Unfortunately, in today's competitive market, businesses can no longer afford to ignore this predicament and must be able to integrate the various data from disparate sources so that they can get a comprehensive analysis of the their performance.

As a result of the highly competitive nature of today's business environment, it is often desirable to be able to view performance metrics from various network sources through a single source in a timely manner. A system that is flexible and comprehensive measuring performance for both the entire business and across various functions and organizations would, therefore, be highly desirable.

### SUMMARY OF THE INVENTION

Accordingly, the present invention is directed to a system and method that enables networks to capture, integrate, measure, monitor, analyze and publish actual performance data from multiple sources and display the grouped results in a convenient and efficient manner through a single user interface. The system and method may interface with a variety of network systems/applications and or databases and may facilitate the creation of reports from data found in virtually any existing system, even systems that are generally not compatible with each other and allow system users to have global view of a supply chain networks even across divisional and/or company boundaries.

In a preferred embodiment, data is retrieved from disparate applications/systems via an Extraction, Transformation and Loading engine and stored in a data warehouse. An On-line Analytical Processing (OLAP) server may then generate Key Performance Indicators (KPIs) from each of the disparate applications using the stored data. The KPIs may then be grouped together and displayed on a single user interface. Non-KPI metrics may also be displayed together with the KPIs on the user interface.

According to another embodiment, the OLAP server may create subject areas used to access the data stored in the database. These subject areas may be mapped directly to the database providing an efficient means of accessing desirable data.

According to another embodiment, a first data is retrieved from a pricing management type application while a second data is retrieved from a supply management or supplier relationship type application. KPIs may be generated from each of the data and displayed through a single user interface.

According to another embodiment, the data stored in the database may be organized into a data hierarchy structure based on dimensions associated with the data. The measures associated with the dimensions may then be aggregated and/or drilled down to provide a more global view of the data and/or a more detailed view of the data.

According to another embodiment, data and KPIs being displayed on the user interface may be exceptionally highlighted based on pre-defined conditions.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention provides for a system and method that allows viewing of data and key performance indicators from disparate systems through a single user interface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1A is a block diagram depicting a system in accordance to an embodiment of the present embodiment in communication with a plurality of network systems;

FIG. 1B is a block diagram depicting a system in accordance to an embodiment of the present invention;

FIG. 2 is a flow diagram depicting the steps for creating a report;

FIG. 3 is an exemplary hierarchical pyramid for different levels of metrics;

FIG. 4 is an exemplary user interface displaying a report showing KPIs based on data from disparate applications;

FIG. 5 is an exemplary user interface displaying a report that shows aggregated data;

FIG. 6 is an exemplary user interface displaying a report which shows the aggregated data depicted in FIG. 5 having been drilled down; and

FIG. 7 is an exemplary user interface displaying a report which shows the data depicted in FIG. 5 having been drilled down even further.

### DETAILED DESCRIPTION OF THE PREFERRED EMBODIMENTS

Reference will now be made in detail to the preferred embodiment of the present invention, examples of which are illustrated in the accompanying drawings.

The invention disclosed herein incorporates by reference the subject matter of co-pending and commonly assigned U.S. Non-Provisional Patent Applications “System and Method for Supply Chain Management, Including Collaboration,” Zarefoss et al., attorney docket number 82001-0189, Ser. No. 09/965,854, filed on Oct. 1, 2001; “System and Method of Monitoring Supply Chain Parameters,” Zarefoss et. al., attorney docket number 82001-0199, Ser. No. 09/984,340, filed Oct. 29, 2001; “System and Method for Supply Chain Demand Planning and Forecasting,” Singh et al., attorney docket number 82001-0193, Ser. No. 09/984,347, filed Oct. 29, 2001; “Network Transport System and Method with Freight Payment Module,” Aruapuram et al., attorney docket number 82001-0123, Ser. No. 09/.882,257, filed Jun. 18, 2001; “System and Method for Ensuring Order Fulfillment,” Jenkins et al., attorney docket number 82001-0197, Ser. No. 09/984,349, filed Oct. 29, 2000; “System and Method for Managing Market Activities, Zarefoss et al., attorney docket number 82001.0328, serial No. 60/336,147 filed on Dec. 6, 2001; “Promotion Pricing System and Method,” Scott et al., attorney docket number 82001.0317, Ser. No. 09/987,706, filed on Nov. 15, 2001; “Target Pricing Method,” Boyd et al., attorney docket number 82001.0312, Ser. No. 09/517,977, filed on Mar. 3, 2000; “Target Pricing System,” Boyd et al., attorney docket number 82001.0313, Ser. No. 09/517,983, filed on Mar. 3, 2000; “System and Method for Integrating Disparate Networks for Use in Electronic Communication and Commerce,” Shannon et al., attorney docket number 82001.0191, Ser. No. 09/927,412, filed on Aug. 13, 2001; and “Dynamic Pricing System,” Phillips et al., attorney docket number 82001.0310, Ser. No. 09/859,674, filed May 18, 2001.

The present invention, embodied in its concepts in part by the NetWORKS OneVIEW™ management software and system offered by Manugistics Group, Inc., dramatically increases profitability by accessing and displaying critical information on how a particular business is performing. The system and method according to the present invention allows users to easily access and analyze information scattered in a number of sources and view the data and analysis through a single interface in an integrated format thus enabling the user to easily evaluate performance parameters of a business network. System users may be any person or business unit belonging to a supply chain network. Thus, a system user may be, for example, any person falling anywhere in a corporate hierarchy from top management down to an assembly line worker. Typically, a supply chain network will be the supply chain network of an enterprise or a network of businesses such as suppliers, customers, retailers, and the like, or a combination of both.

In preferred embodiments of the present invention, a system comprising a web server, a data warehouse and an On-Line Analytical Processing (OLAP) server is provided that integrate network optimization, enterprise resource planning (“ERP”), point-of-sale (“POS”) and other data sources for global views of a given single entity or collaborative trading network. The present invention enables users, based on industry-standard OLAP technology, to perform operational monitoring, performance measurement, business process design, and network policy setting. Thus, multi-dimensional analyses are supported to increase the speed, accuracy, and efficiency of knowledge discovery and proactive decision-making.

In preferred embodiments of the present invention, the warehouse system is integrated with a given company's (or collaborative entity's) other business management applications, including Enterprise Profit Optimization and ERP systems, financial systems, customer relationship management systems, and POS data providers. Using this warehoused data, the present invention provides an intuitive, out-of-the-box decision-support system that alerts where action is required, analyzes causality, and supports the best business decisions.

Systems according to preferred embodiments comprise components that are extendable over time and configurable, meaning that they can align with specific existing and evolving business processes. Furthermore, embodiments of the present invention preferably provide support for multiple (optionally, user defined) interaction styles and information delivery modes such that it supports an extended user base throughout global and/or collaborative trading networks.

The various features and benefits of the present invention include pre-built analysis, logic and data warehouses, to reduce implementation time and costs. Other benefits includes libraries of predefined measures and metrics that increase the power of provided analyses, extendable and configurable components to aligns with existing business processes, and ease future extensions. Finally, the present invention provides for analytical breadth and multiple delivery modes to extend the user-base throughout an entire organization and a robust OLAP/data warehouse architecture that provides scalability, integration and lower costs.

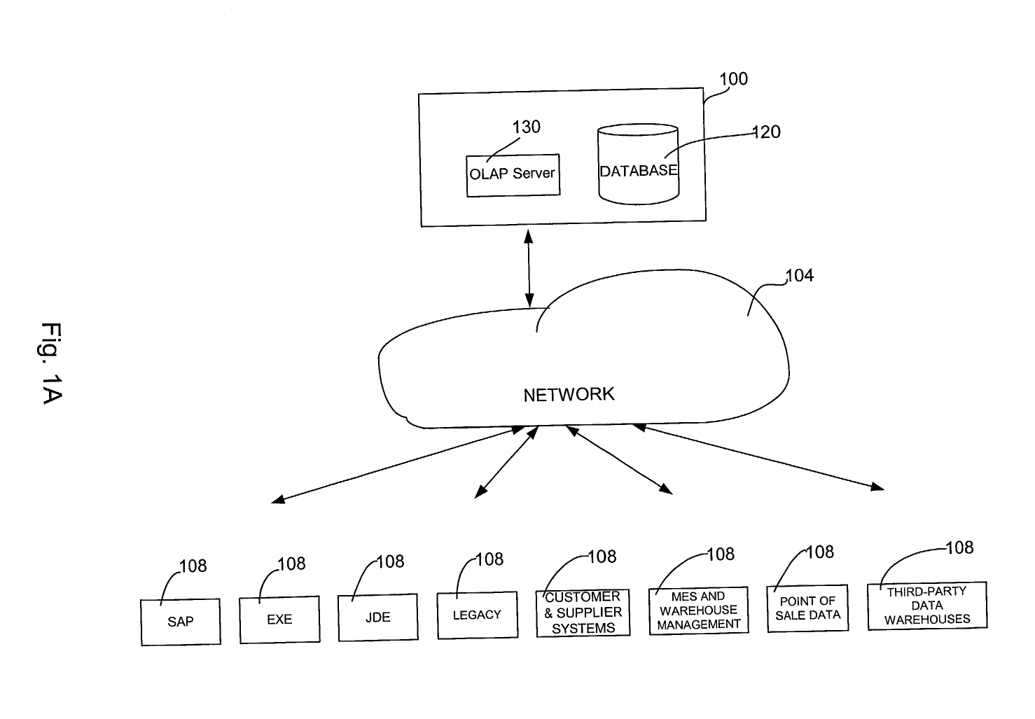

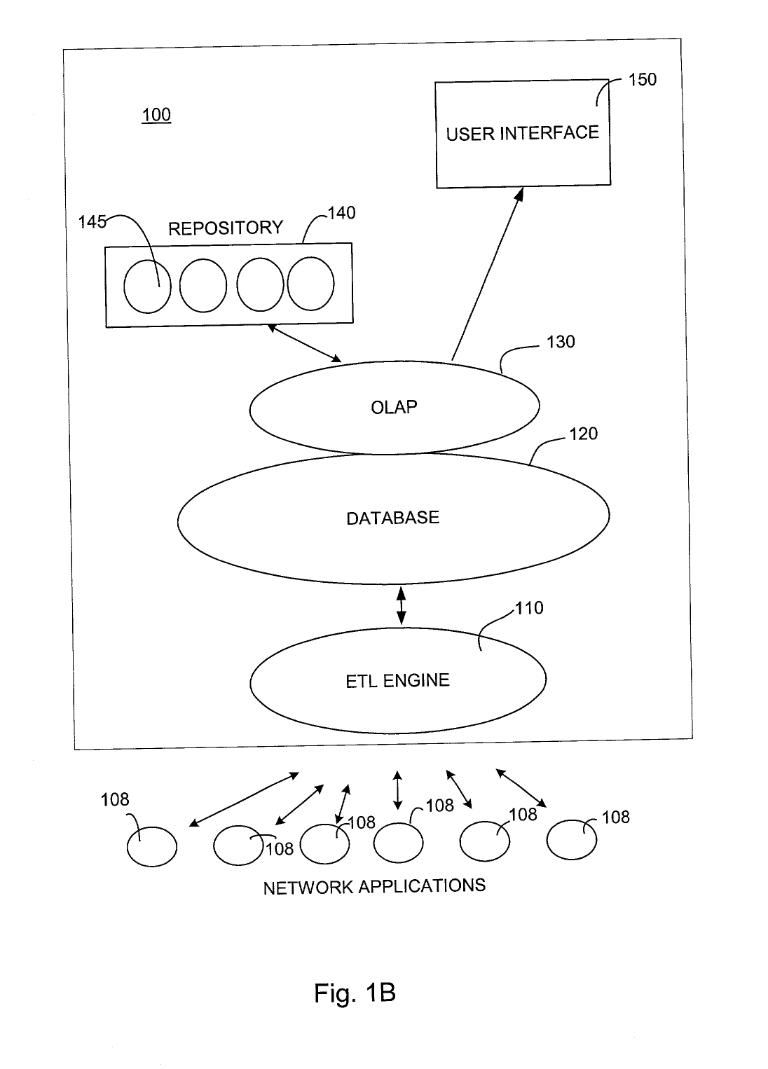

Referring to the block diagram in FIG. 1A depicting a system 100, according to one embodiment of the present invention, in electronic communication with supply chain network applications/systems 108. The system 100 may be located in proximity or remotely located from network applications 108 and is in electronic communication with the network applications 108 via an electronic network 104 such as the Internet, an Extranet, a WAN, a LAN, an Intranet, and the like. The network applications 108 may include several types of network applications that may be incompatible or disparate with each other.

Referring now to FIG. 1B showing another block diagram that depicts another view of the system 100 in electronic communication with several network applications 108. These applications 108 may be broadly classified into at least three application groups. These groups include a group of applications for supply chain management, a group of application for supplier relationship, and a group of applications for pricing management. For example, Manugistics' NetWORKS Demand, NetWORKS Transport, NetWORKS Monitor (for Collaborate, Procurement or Market Manager), are commercially available applications addressing supply chain management functionalities. On the other hand, Manugistics' NetWORKS Component Management is a commercially available application that address supplier relationship functionalities. Finally, Manugistics' NetWORKS Target Pricing, NetWORKS Promotions and NetWORKS Precision Pricing are commercially available applications that address pricing management functionalities. The data associated with each of these application groups may be disparate data that are typically not viewed together or integrated because each type of data serves a substantially different purpose. Thus data associated with applications belonging to one group will likely be disparate with data associated with applications belonging to another group and therefore, cumbersome to integrate, process and display collectively. For example, data associated with a transportation system, such as the one described in U.S. patent application Ser. No. 09/882,257, which belong to the supply chain management group, relates to information associated with transportation of goods for a supply network. Meanwhile, data associated with a pricing management system, such as the one described in U.S. patent application Ser. No. 09/876,218, which belongs to the pricing management group, relates to optimal product pricing of network goods. As a result, the formatting of the data, for example, as it relates to the time periods associated with data buckets or units of measure or product identifiers, for each of the data associated with each application may be substantially different or incompatible thus making integration of the data cumbersome. The logistical applications 108 may also be customized applications specifically tailored to particular customer needs, for example, the legacy system of a trading partner, thus increasing the difficulty of integrating, processing and displaying the data on a single user interface.

The network applications/systems 108 are in electronic communication with an Extraction, Transformation and Loading (ETL) engine 110, for example, a system such as the commercially available application sold by Manugsitics called NetWORKS WebConnect. Further detail relating to the ETL engine 110 may be found in U.S. patent application Ser. No. 09/927,412. The ETL engine 110 provides a means for retrieving data from various disparate network applications/systems 108. The ETL engine 110 interfaces with a database 120. In a preferred embodiment, the database 120 is a multidimensional database, for example, Oracle's DataMart. The database 120 stores data from the various network applications 108 via the ETL engine 110. The data contained in the database 120 is preferably refreshed or updated periodically, for example, by batch processing. The database 110 also interfaces with an On-Line Analytical Processing (OLAP) server 130, for example, Seibel's Analytics (formerly known as nQuire), which manages the data contained in the database and is able to organize the data in the database 120. The OLAP 130, in this embodiment, also acts as a reporting engine used to map reporting data from a repository 140 back to the database 120. The repository 140 may be organized into different subject areas 145 that generally corresponds to the business subject areas that a user may wish to view on a user interface 150. The user interface 150 may be a CRT utilizing a web browser. The OLAP server 130 may query for, integrate, slice and dice, manipulate and process the data stored in the database 120 to produce results that are readily understandable and highly usable to the system user. The results of the data query/processing/manipulation by the OLAP server 130 may be displayed on the display 150 in text format or in various graphical forms such as bar or line charts. Specific information relating to some of the components of the system 100 and other key features are discussed in greater detail below.

The subject areas 145 in the repository 140 are preferably multidimensional and represent logical business related groupings of data. The creation of the subject areas 145 allow users to turn data stored in relational databases, such as NetWORKS Demand (described in U.S. patent application Ser. No. 09/984,347), into meaningful, easy-to-navigate approach to acquiring business information that originate from disparate sources. Typically, a subject area represents information pertinent to a particular area of the business needs of a particular user community. Each subject area contains a set of measures (quantitative data such as unit sales) and dimensions (descriptive data such as type of product or store location). Types of subject areas 145 that may be included in the repository 140 includes, for example, Accounting, Actual Stock Out, Forecast Performance, Inventory Turns, Order Metrics, Production Plan, Projected Stock Out, Resource Utilization, Precision Pricing, Precision Pricing Alert, Promotion, and Target Pricing. Specific details relating to each of these subjects may be found in the references incorporated above.

According to a preferred embodiment of the present invention, the OLAP server 130 may generate performance metrics called Key Performance Indicators (KPIs) based on the data stored in the database 120. KPIs may be created using data from one or more application groups (i.e., supply chain management group, supplier relationship and pricing management). A KPI may be predefined by the system, or may be a user defined KPI. The KPI metric calculations may be based on the American Production and Inventory Control Society (APICS) standards.

The data stored in the database 120 may be defined by “dimensions” and by “measures.” Briefly, dimensions are qualitative types of data such as location, product identifier, month, and the like. In contrast, measures are quantitative type of data such as number of units, weight, volume, and the like. Each bucket of data will typically be associated with a set of both dimension and measure data. Dimension type data becomes highly useful in creating hierarchies for data aggregation and drill downs. A more detailed discussions regarding hierarchies is provided below. In any event, the system 100 allows users to view both generally unprocessed data from network applications 108 (broken down into a hierarchical level) and their corresponding performance metrics.

Although system users may define user defined performance metrics (i.e., KPI), the system 100 provides for pre-defined performance metrics. Pre-defined performance metrics (i.e., KPI) may be classified into at least four broad categories of metrics. The groups and individual metrics may be classified as follows:

1. Inter-Enterprise Metrics

The KPIs included in this group includes on-time deliveries metrics, order line fill metrics, and supplier quality metrics.

The on-time deliveries metrics may be calculated as the number of orders received on time divided by the total number of orders placed. The result is then multiplied by 100 to obtain a percentage.

On-time deliveries metric=(On Time Orders/Order Count)×100.

The following assumption applies to the calculation: an order is considered to be delivered on time from the supplier when every line on the order passes both of the following tests: the received from supplier date is on or before the need date; and the quantity shipped is greater than or equal to the quantity ordered.

The Order Line Fill Metric may be calculated as the number of order lines filled completely and on time during the period, divided by the total number of order lines ordered during the period. The result is then multiplied by 100 to obtain a percentage.

Order Line Fill Metric=(Order Line Filled/Order Count)×100

This formula may be used to calculate both supplier and customer on-time deliveries. Assumptions may be made as it relates to this calculations for example, an order line is considered filled when the quantity shipped is equal to the quantity ordered and/or the received from supplier date is on or before the need date.

The Supplier Quality Metric may be calculated as the completed order (which is the quantity received from the supplier minus the quantity rejected) divided by the order quantity. The result is then multiplied by 100 to obtain a percentage.

Supplier Quality Metric=(Completed Order/Quantity Ordered)×100

Certain assumptions may be made in implementing the calculation. For example, the calculation is performed on the order detail information without regard to what order the line actually belongs to, as long as the order information matches the report criteria. An order may be considered to be delivered on time from the supplier when every line on the order passes a test: the received from supplier date is on or before the need date.. And finally, any comparison of dates is performed on the order date.

2. Supply Analysis

The supply analysis metrics category includes the following calculated KPI metrics:

The In Transit Metric requires no calculations per se. Instead, this metric is a series of reports that visualize “in transits.” In this metric, the following assumptions may apply: when a report requires a date selection, the date field is used for the comparison; the generation date field is only used with generation analysis reports; and nongeneration analysis reports use the most recent generation available unless the user chooses a different generation.

The Actual Out of Stock Occurrences Metric may be calculated as the count of rows that match the report details. No summations of quantities or other calculations are required. In this case, it may be assumed that any date comparisons are performed based on the actual stock out date.

The Actual Out of Stock Days Metric may be calculated as the sum of the number of days during the given time period that a SKU (or relevant dimension) was out of stock. No summations of quantities or other calculations are required. In this calculation, it may be assumed that any date comparisons are performed based on the actual stock out date. This metric may not be used if the actual duration the stock out lasted is unavailable.

The Actual Out of Stock Quantities Metric may be calculated as the sum of the out of stock quantities during the given time period for which a SKU (or relevant dimension) was out of stock. No summations of quantities or other calculations are needed. It may be assumed for purposes of this calculation that any date comparisons are performed based on the actual stock out date. However, this metric cannot be implemented if the data relating to the time period for which the stock is out(stock out duration) is unavailable.

The Projected Out of Stock Occurrences Metric may be calculated as a count of rows that match the report details. No summations of quantities or other calculations are required for this metric. For this calculation, it can be assumed that: information will be updated at least one month into the future; the preferable duration will be the planning duration; and all date selections are made based on the projected stock out date.

The Current Projected On-Hand Decomposition Metric may be calculated as the prior period's projected on-hand inventory minus the total of the scheduled receipts, frozen assignments, planned orders, total arrivals, and total in-transits minus the total demand.

Current Projected On-Hand Decomposition Metric=Prior Projection On Hand Inventory−(scheduled receipts+frozen assignments+planned orders+total arrivals+total in-transits−total demand)

Here, it may be assumed for purposes of calculation that the data are displayed from the most current generation available and/or generations cannot be compared to actuals due to on-hand information not being readily available at this granular level.

The Days of Supply Metric may be calculated as the quotient of the inventory value for the current period divided by the cost of goods sold (COGS) value over the period. This result is then divided by the number of days in the period:

Days of Supply Metric=(Inventory value/COGS value)/Number of Days in Period

The number of days in the period refers to the duration of the report. This duration must be of no less granularity (for example, quarter, week, day) than that of the least granular fact, which is usually the COGS information. COGS value over the period is the sum of the COGS values for each of the months in the period. Inventory value for the current period is the inventory quantity multiplied by standard cost. In this calculation, certain assumptions may be made. For example, monthly inventory is refreshed as frequently as Manugistics' Supply Chain Planning and Optimization's (SCPO) SKU.OH value is updated if SKU.OH is being used (the SCPO SKU.OH value is the stock keeping units on hand, that is, how much of a product that is on hand at an individual location), otherwise, this timing is determined based on individual client's needs. It may also be assumed that a refresh of this data is required on the last day of the month (or the end of the period). Further, it may be assumed that COGS and monthly inventory are stored in the same periodicity. Finally, it may be assumed that COGS and monthly inventory are compared at the same level of granularity.

The Inventory Turns metric may be calculated as the quotient of the summation of the COGS in the period divided by the summation of inventory in the period. This result is then divided by the number of periods.

Inventory Turns metric=(COGS Quantity/Inventory Quantity)/Number of Periods

In this calculation, the following assumptions may be made: monthly inventory is refreshed as frequently as SCPO's SKU.OH value is updated if SKU.OH is being used, otherwise, this timing is determined based on individual client's needs; a refresh of this data is required on the last day of the month (or the end of the period); COGS and monthly inventory are stored in the same periodicity; and COGS and monthly inventory are compared at the same level of granularity.

3. Manufacturing Analysis

There are at least three types of manufacturing analysis metrics: Production Plan Compliance Metrics, Actual Resource Efficiency Metrics and Projected Resource Efficiency Metrics.

The Production Plans Compliance Metric may be calculated as the actual production in units or dollars divided by the planned production in the same measure (units of dollars) as actual production. The result is multiplied by 100 to obtain a percentage.

Production Plans Compliance Metric=(Actual Production Quantity/Planned order quantity)×100

The following assumptions apply to this calculation: data is initially captured on the first day of the month (or the first day of the production period); data can then be captured at intervals throughout the production period; and standard cost rules is applied. The standard cost rules includes first, the SKU dimension is checked for standard cost. If the SKU dimension's standard cost field is empty, the item dimension is checked. If the item dimension's standard cost field is also empty, reports cannot be evaluated by dollars (currency).

The Actual Resource Efficiency Metric may be calculated as the actual hours used for the period divided by the standard hours for the period. The result is then multiplied by100 to obtain a percentage.

Actual Resource Efficiency Metric=(Hours Used/Standard Hours Duration)×100.

No assumption is needed in this calculation.

The Projected Resource Efficiency Metric may be calculated as the total load from production for the period divided by the total capacity for the period. The result is then multiplied by100 to obtain a percentage.

Projected Resource Efficiency Metric=(Hours Used/Load Duration)×100

No assumption is required with regard to this calculation.

4. Forecast Accuracy Metrics:

At least two types of forecast accuracy metrics may be provided: Absolute Percent Error Metric and Mean Absolute Percent Error Metric.

The Absolute Percent Error (APE) Metric may be calculated as the summation of the absolute value of the difference of the base or total forecast minus the total history divided by the summation of the total history over the given period. The result is then multiplied by100 to obtain a percentage.

APE Base Forecast=[abs(Base Forecast−Total History)/Total History]×100

APE Total Forecast=[abs(Total Forecast−Total History)/Total History]×100

Assumptions are not required for these calculations.

The Mean Absolute Percent Error Metric may include two separate calculations. Either APE is calculated based on statistical forecasts divided by the number of demand forecasting units (DFUs) in the APE calculation, or APE is calculated based on total forecasts dievided by the number of DFUs in the APE calculation.

Mean APE of Base Forecast=APE Base Forecast/Count of DFU

Mean APE of Total Forecast=APE Total Forecast/Count of DFU

Assumptions are not required for these calculations.

The OLAP server 130 allows system users to view data in an aggregated format. This allows users to get a higher level or global view of metrics. For example, data relating to a specific product may be divided into data buckets for each specific store location in a given sales district. The system allows users to view the aggregated data for all stores within the district thus providing a more global view of the data such as the KPI. Of course, data may also be aggregated based on longer time periods.

The system may also allow viewers to view data in drill down form. By drilling down, users view the data in exactly the opposite of what is accomplished in data aggregation. Instead of viewing data globally, users may view the data in finer detail or smaller data buckets. Thus, the system allows users to start with high-level aggregate data and then penetrate down to analyze specific details. For example, referring back to the above example, the user may view the data for specific store location rather than by sales districts. In another example, a system user may start by viewing overall company performance and the drill down to view metrics on select business units, divisions, organizations, or even specific suppliers or customers. The drill down and aggregation of data is primarily as a result of organizing the data into a hierarchical architecture. Further details regarding the concept of drill down, data aggregation and hierarchy may be found in U.S. patent application Ser. No. 09/965,854.

The ability to drill down will generally depend upon the granularity of the data stored in the database 120. Typically, it is generally preferable that the granularity of the data stored in the fact table (database) be of the same “duration” as the client's business cycle. For example, if the client forecasts in weekly basis, the forecast data should be stored in weekly buckets as well. However, if the data is needed in daily buckets, the information should be stored in daily buckets. Generally, data can be aggregated upon, but cannot be drilled into below the stored detail level.

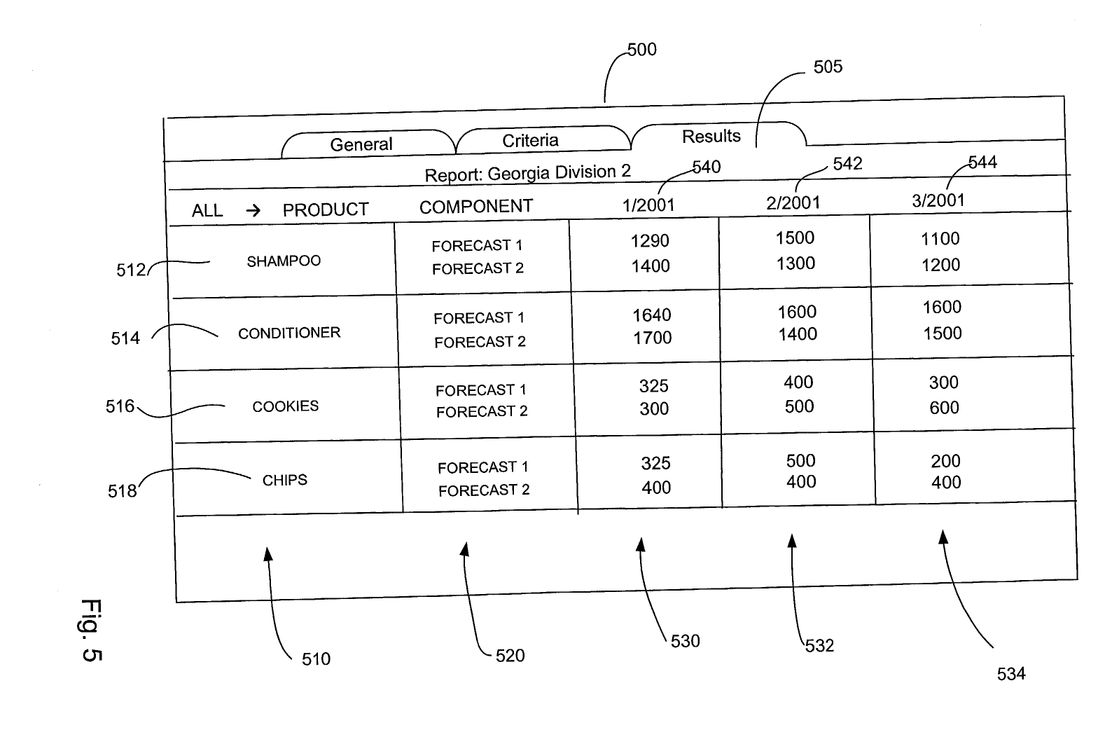

The ability to drill down or aggregate data may be based on the system's ability to organize the data into a hierarchical structure. The hierarchical structure will typically be based upon the dimension data associated with the data buckets. For example, suppose a user is interested in obtaining sales figures from various perspectives of corporate hierarchy such as seeing the sales figures for a region, for a sales district and for a particular store. A data hierarchy structure may be created by employing three dimensions called region, sales district and store identification. In this scenario, the fundamental data bucket may be sales figures for each store. The sales figures for each district would be the aggregation of sales figures for all of the stores located within each district. Similarly, the sales figures for a region will be the aggregation of sales figures for all of the sales districts for that region. Although this example is limited to geographical dimensions, hierarchical structures may also be based on other types of dimensions such as time or a combination of different types of dimensions. A more detailed explanation of this concept is further discussed below in reference to FIGS. 5 through 7 and may also be found in the reference cited above in U.S. patent application Ser. No. 09/965,340.

The system 100 may also provide a feature called “exception highlights.” This feature allows system users to pinpoint identified conditions within the data without having to review every element of the report to determine areas where the condition exists. With this feature, colors and images can be used to mark various data conditions in a report. In other words, the feature highlights displayed data that have met specified conditions. It makes viewing of reports quicker and easier and may help focus the attention of the viewer to important data. Various ways may be implemented to highlight the data that meet pre-set conditions. For example, when a piece of data meets a pre-set condition, the data may be displayed in, for example, contrasting fonts, and/or colored and/or designated by icon (e.g., flags, arrows, etc.). To create an exception highlight, first identify the dimension and measure that the exception will apply to. After identifying the dimension and measure, define the condition (criteria) that will initiate the highlighting. Finally, define the type to highlighting to be used.

The performance metrics may be viewed by system users on the user display via “reports.” Reports are typically designed by system users and customized so that only those data, that are of interest to the user are, at least initially, displayed on the user display.

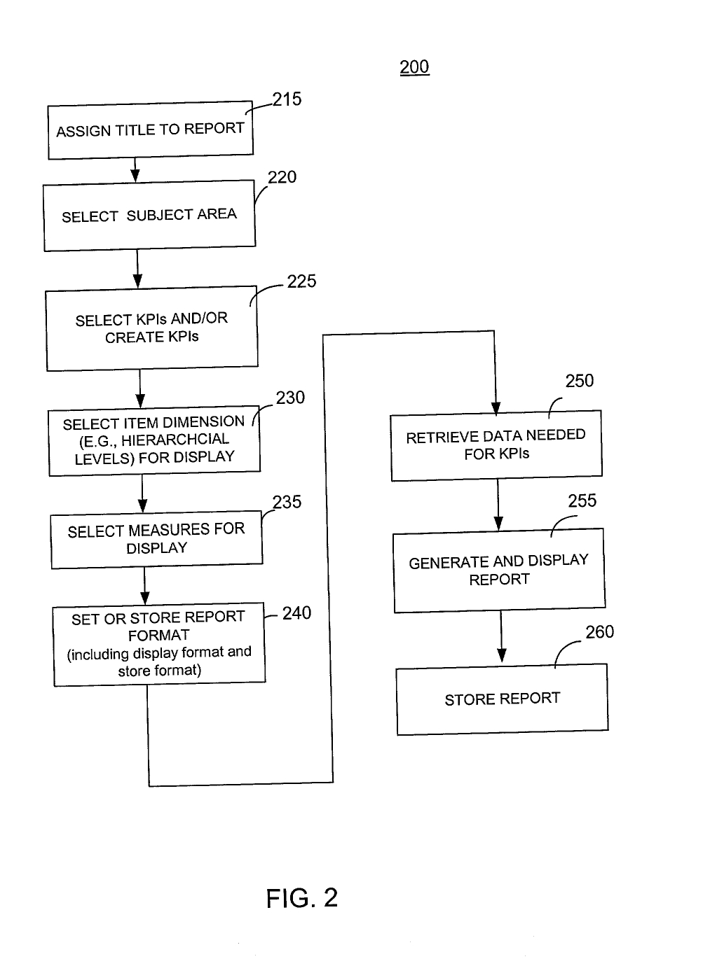

There are two general phases relating to the generation of reports. The first phase involves the creation of a report format or template and the second phase involves the actual generation of the report. Referring now to the flow diagram in FIG. 2 depicting a process for creating reports according to one embodiment of the present invention. The first phase begins when at step 215 a title (e.g., identifier) is assigned to the report being created. The title may be used to call or retrieve the report at a later time. At step 220, subject area[s] is selected. The selected subject area[s] is where the data needed for the desired KPIs will be grouped. At step 225, select and/or create KPI[s] that will be contained in the report. In this step, customized KPI[s] may be created and/or existing KPI[s] may be selected. At step 230, select a dimension or dimensions for display. The selected dimension or dimensions is used to create hierarchy for viewing the results at a desired metrics level. At step 235, select a measure or measures for display. At step 240, set and/or store report format. This step allows users to call up or refresh the report having the same KPIs and the same display format at some later time. The second phase begins when data needed for generating the selected and/or created KPIs is retrieved at step 250. At step 255, generate and display the report. At step 260 store the report for later viewing and/or refreshing. Note that those skilled in the art will recognize that the order in which the steps are outlined in the flow diagram of FIG. 2 is not strictly required and may be placed in a different order. For example, step 235 may occur before step 230 without changing the overall results of the process 200.

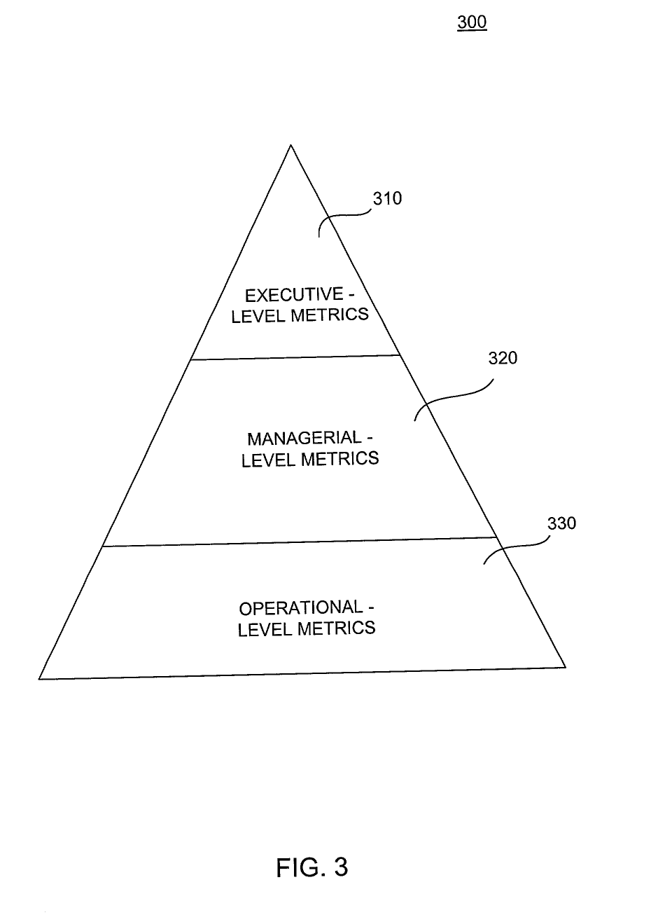

Reports will typically be formatted according to the needs of individual users. The needs of the user will often depend up the user's position in the supply chain network or corporate hierarchy. Thus, KPIs (i.e., performance metrics) that may be displayed on a user interface may also be grouped into hierarchical levels that generally align to the user's network hierarchy. The usefulness of hierarchies may be best illustrating by the following example. Referring now to FIG. 3 depicting an exemplary hierarchical pyramid 300 for different levels of metrics. In this pyramid, there are three levels, the Executive-Level Metrics 310, the Managerial-Level Metrics 320 and the Operational-Level Metrics 330. In this example, a particular system user will be associated with one of the three levels. A user will have preferences as to the types and formats of metrics that the user will typically want to view. That is, different levels of the organization look at the performance of the supply chain in different ways and typically want to analyze the data differently.

Executive level metrics 310 will be generally aligned to strategic objectives. Thus, metrics in this group will focus on crossing divisions and functional areas within the business. The “big picture” is generally desirable for those in the executive level 310 and the metrics will typically contain highly aggregated data. The metrics will also typically be process-oriented, less geographical, cross-divisional and effect rather than cause-related.

Managerial level metrics 320 typically monitor the strategic plan at a finer level than those found in metrics associated at the executive level 310. System users interested in metrics at this level generally look at the tactical level programs that execute the executive vision and set strategy for a division or a group. Reviewing causal relationships and fine-tuning at this level is the key. The manager-level metrics can be both geographical and divisional. They are also generally aligned to executive measures, functional and disaggregated, sub-process or task-related and cause-related or diagnostic.

Operational-level metrics 330 typically provides analysis at the tactical level. System users who are interested in these metrics typically ask questions such as how well are the goals of the manager being met in their area of responsibility? The manager-level metrics can be both geographical and divisional. Further, the metrics at this level may be aligned to managerial measures, highly detailed and task-specific.

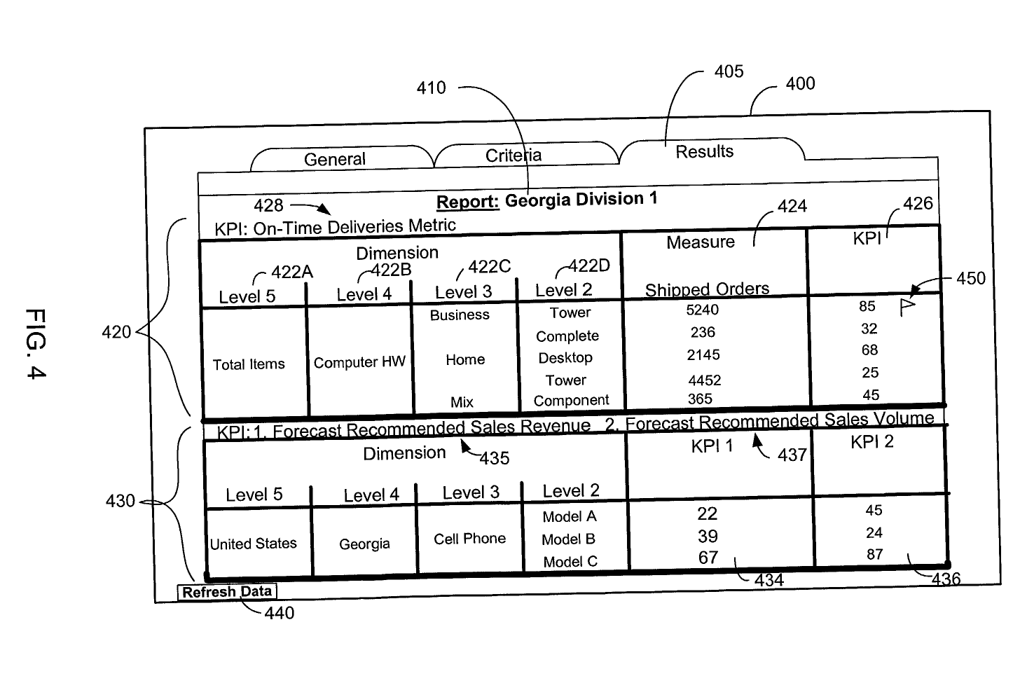

Referring to FIG. 4 depicting an exemplary user display 400 showing an exemplary report 405 that provides KPIs using data from two separate and disparate applications 108. In this example, the report 405 appears in tabular form. The title of the report “Georgia Division 1” is indicated at the top of the report at 410. The report 405 comprises of two parts, an upper portion 420, and a lower portion 430. The upper portion 420 shows general metrics and Key Performance Indicators associated with supply chain management applications such as Manugistics' NetWORKS Transport (as described in U.S. patent application Ser. No. 09/882,257). The first four columns 422A to 422D on the left side show dimensions that have been organized into hierarchical levels. The second column from the right 424 shows a measure called “shipped orders” for each of the items listed in column 422D. The far right column 426 for the upper portion 420 shows KPI values for “On-Time Deliveries Metric” as indicated at 428 and is based on data associated with those found in supply chain management type applications. The lower portion 430 relates to data associated with supplier pricing revenue optimization type applications (i.e., pricing management type applications). Specifically, in the second column from the far right side 434, KPI values for “Forecast Recommended Sales Revenue,” as indicated at 435, is shown. Similarly, in the far right column 436 of the lower portion 430, the KPI values for “Forecast Recommended Sales Volume” as indicated at 437 is shown. Note that both KPI values in columns 434 and 436 are based on data associated with pricing and revenue optimization type applications. A “refresh data” button 440 is shown at the bottom of the display. The present invention also is also able to provide exception highlighting to show when a particular pre-defined condition has been met. For example, in FIG. 4, an icon shaped as a flag is placed next to a metric value which has met a particular condition as indicated at 450. The predefined condition may be that a particular metric is at a particular value, is greater than a particular value, is less than a particular value, or any other condition that is definable. Of course, methods for highlighting are not restricted to the placement of an icon next to the metric being flagged. Rather, those skilled in the art will recognize that there are various ways to highlight a metric when a particular condition has been met.

A drill down/aggregation feature allows users to view supply chain data, both general metrics (metrics that are not KPI metrics) as well as KPIs in aggregated formats or in drill down formats. FIGS. 5 through 7 shows an exemplary user displays that demonstrate the results of a drill down. FIG. 5 depicts a user display 500 showing a user report 505, 514, 516, and containing forecasting data for several products as indicated by 512, 518. The data contained in the right three columns 530, 532, and 534 are aggregate data for each of three different periods as indicated by 540,542, and 544. Two forecasts are shown for each of the products as indicated in column 520. If a user wishes to see a more detailed view of the data displayed in display 500, for example, the product “shampoo” in row 512, then the user would then drill down the data being displayed.

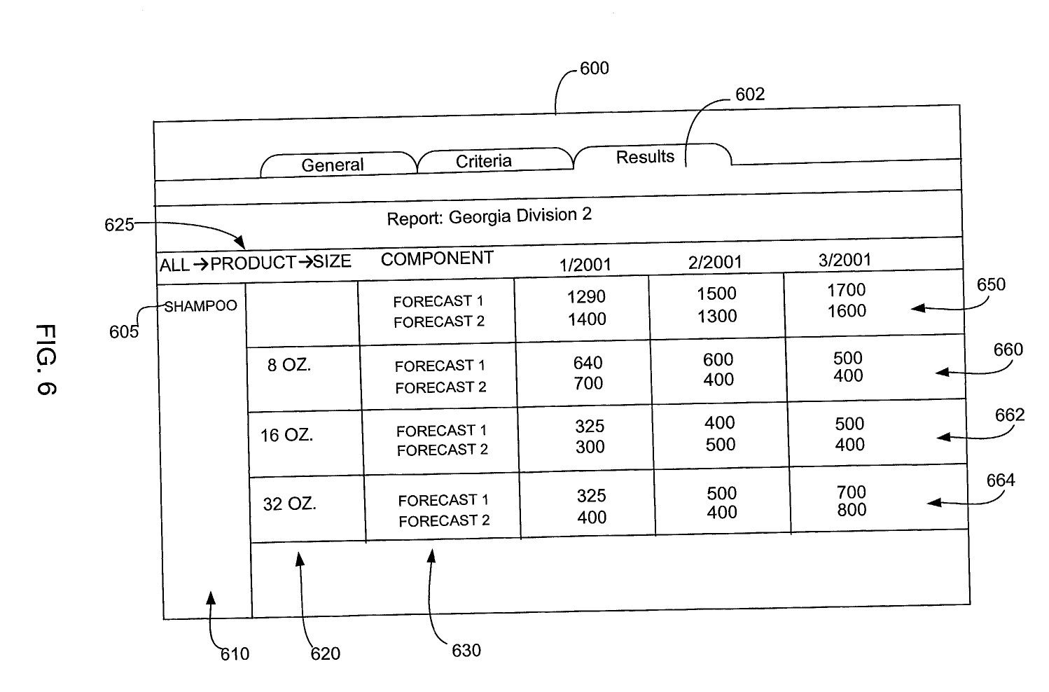

Referring now to FIG. 6 showing a user display 600 with a drill down version of the same report 602 as the report 502 in FIG. 5. The drill down report 602 shows a broken down version of the data displayed in FIG. 5. In the report, the shampoo is broken down into shampoo sizes as indicated in column 620. Note that the first two columns on the far left side 610 and 620 shows the hierarchy levels (a product, “shampoo,” and size, “8 oz.,” “16 oz.,” and “32 oz.”) as indicated at 625. The sum of the non-KPI data in rows 660, 662, and 664 is equivalent to the data found in row 650 (which is the same as row 512 if FIG. 5). Thus, FIG. 6 shows both the aggregated values for forecasts for shampoo and the drill down values for each of the different sized shampoo. The data displayed in FIG. 6 may be even further drilled down.

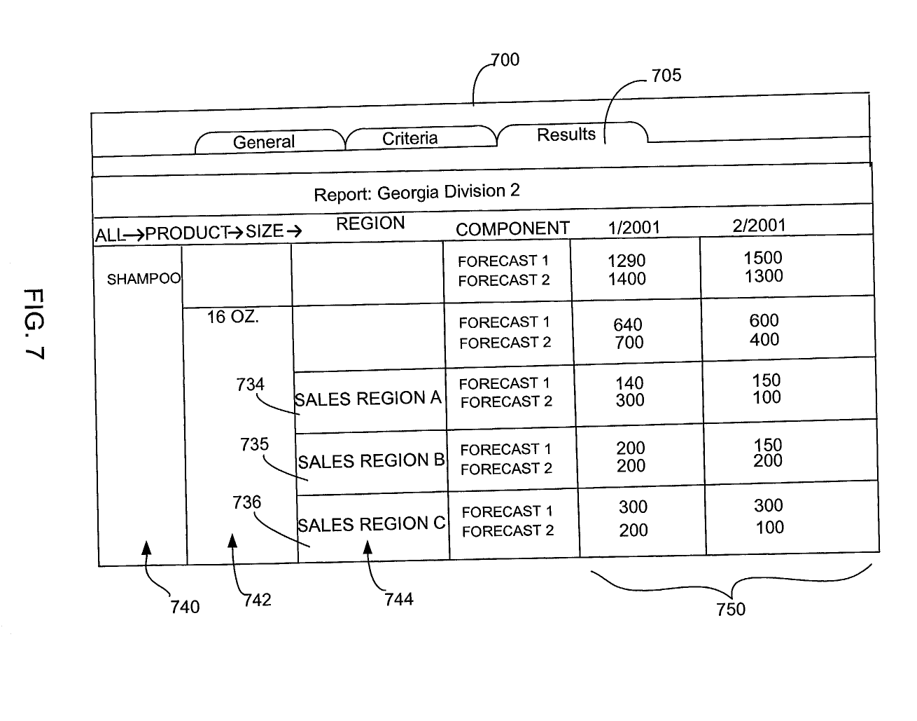

Referring to FIG. 7 showing another user display 700 that further drills down the results 705 for Shampoo values (see row 512) of FIG. 5. The data in the far right two columns (as indicated by 750) are forecast values for shampoo (as indicated by column 740) of 16 oz. size (as indicated by column 742) broken down by regions (as indicated by column 744). Note that columns 740, 742, and 744 are dimensions while the two far right columns (as indicated by 750) are measures. Although the data being drilled down in FIGS. 5 to 7 are non-KPI metrics, those skilled in the art will recognized that the drill down/aggregation feature may easily be implemented using KPI values.

The system 100 may be operated with, for example, Windows NT or UNIX web servers. The system may also be supported by BEA WebLogic Server 6.0, Service Pack 2 (SP2), Manugistics WebWORKS Foundation 6.2.0.3, Common Security Model (CSM) database schema, Oracle 8.1.7 or any other future versions of these application or equivalent applications known to those skilled in the art.

It will be apparent to those skilled in the art that various modifications and variations can be made to the claimed invention without departing from the spirit or scope of the invention. Thus, it is intended that the present invention cover the modifications and variations of this invention provided that they come within the scope of any claims and their equivalents.

What is claimed:

1. A method for displaying metrics and performance measurements from two or more network applications, the method comprising:
retrieving a first data from a first network application;
retrieving a second data from a second network application, said second data is disparate from said first data;
storing said first and said second data;
creating a first key performance indicator from said first data;
creating a second key performance indicator from said second data;
and
displaying said key performance indicators through a single user interface.

2. The method as recited in claim 1, further comprising the step of creating two or more subject areas.

3. The method as recited in claim 2, wherein said step of creating a first key performance indicator further comprises the step of using one of said subject areas to access said first data.

4. The method as recited in claim 3, wherein said step of creating a second key performance indicator further comprises the step of using one of said subject areas to access said second data.

5. The method as recited in claim 1, wherein said first network application is a pricing management application.

6. The method as recited in claim 6, wherein said second network application is an application from the group consisting of supply chain management and supplier relationship applications.

7. The method as recited in claim 1, wherein said first data comprising of a dimension and a measure data.

8. The method as recited in claim 7, further comprising the step of creating a data hierarchy structure based on said dimension data.

9. The method as recited in claim 8, further comprising the step of using said data hierarchy structure to aggregate said first data.

10. The method as recited in claim 9, further comprising the step of drilling down said aggregated data.

11. The method as recited in claim 1, further comprising the step of displaying one of said first and said second data on said user display.

12. The method as recited in claim 11, further comprising the steps of defining a pre-define condition and highlighting said data being displayed based on said pre-defined condition.

13. The method as recited in claim 1, further comprising the steps of defining a pre-defined condition and highlighting one of said key performance indicator based on said pre-defined condition.

14. The method as recited in claim 1, further comprising the step of creating a third key performance indicator from said first and said second data.

15. A system for displaying data and results of performance analysis from two or more network applications on a user interface, comprising:
an ETL engine, said ETL engine in electronic communication with a first network application and a second network application, wherein said second network application is disparate from said first application;
a database interfaced with said ETL engine;
an OLAP server interfaced with said database, said OLAP server adapted for generating a first key performance indicator based on data associated with said first network application and a second key performance indicator based on data associated with said second network application; and
an user interface for displaying said first and said second key performance indicators on a single display.

16. The system as recited in claim 15, wherein said first network application is a pricing management application.

17. The system as recited in claim 16, wherein said second network application is an application from the group consisting of supply chain management and supplier relationship applications.

18. The system as recited in claim 15, wherein said OLAP server further adapted for creating a data hierarchy structure based on dimensions of data associated with said network applications.

19. The system as recited in claim 18, further comprising a means for using said data hierarchy structure to aggregate said data.

20. The system as recited in claim 19, further comprising a means for using said data structure to drill down said data.

21. The system as recited in claim 20, further comprising a means for providing exception highlighting.

22. The system as recited in claim 15, wherein said OLAP server adapted for generating subject areas used to access data in said database.

23. The system as recited in claim 15, wherein said first key performance indicator further based on said data of said second network application.

24. A system for monitoring and evaluating a plurality of disparate supply chain network system through a single user interface, comprising:
means for acquiring a first data from a first supply chain network system and a second data from a second supply chain network system, wherein said first and said second data are disparate, said means further comprising a means for making compatible said disparate data;
means for storing said first and said second data, said storing means interfaced with said acquiring means;
means for generating a first key performance indicator based on said first data and a second key performance indicator based on said second data; and
means for displaying said data and said key performance indicators.

25. The system as recited in claim 24, wherein said generating means further comprises a means for generating subject areas, said subject areas used to access said first and second data.

26. The system as recited in claim 24, further comprising a means for creating a data hierarchy structure based on dimension associated with said data.

27. The system as recited in claim 26, further comprising a means for aggregating said data.

28. The system as recited in claim 27, further comprising a means for drilling down aggregated data.

29. The system as recited in claim 24, further comprising a means for exception highlighting.

30. The system as recited in claim 24 wherein said first supply chain network system is a pricing management application.

31. The system as recited in claim 30 wherein said second supply chain network system is an application belonging to a group consisting of supply chain management and supplier relationship applications.

32. The system as recited in claim 24 wherein said generating means generates a third key performance indicator based on said first and said second data.
